(19) United States
(12) Patent Application Publication
(10) Pub. No.: US 2003/0220142 A1
(43) Pub. Date: Nov. 27, 2003

(54) Video Game controller with display screen

(76) Inventor: Mark Siegel, Fort Worth, TX (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/338,703

(22) Filed: Jan. 9, 2003

Related U.S. Application Data
(60) Provisional application No. 60/381,817, filed on May 21, 2002.

(51) Int. Cl. A63F 13/02

(52) U.S. Cl. 463/37

(57) ABSTRACT

A video game controller assembly having a controller adapted to communicate with a video game console for interfacing with a video game. A display is attached to the controller for displaying an image corresponding to a video signal received from the video game console.

### CROSS-REFERENCE TO RELATED APPLICATION

This application claims the benefit under 35 U.S.C. §119(e) of U.S. Provisional Patent Application Serial No. 60/381,817, filed May 21, 2002, which is hereby incorporated by reference in its entirety.

### FIELD OF THE INVENTION

The present invention relates to a video game system including a video game console and a video game controller having a display screen. More particularly, the present invention relates to a video game controller having an integral display screen. A display screen attached to the controller provides a more portable video game system.

### BACKGROUND OF THE INVENTION

Existing standard video game systems generally include a video game console, at least one controller and a display screen, where the display screen may be a standard television, HDTV, digital TV, etc. Software inserted into the video game console provides the programs necessary to play a video game. The video game console is connected to a television for transmitting audio-video signals to the television to create a video display on a television screen. The controller is connected to a port of the video game console for transmitting signals to the central processing unit of the video game console. The controller signals are processed by the processor in the video game console to modify the video signal sent to the television, thereby allowing characters or images of the video display to be manipulated with the controller. Video game systems relying on a television screen to be the video display are bulky and, therefore, not readily portable.

Hand-held video game consoles provide a portable video game. However, they have several disadvantages compared to standard video game consoles. Hand-held game consoles have significantly less processing power and a much lower screen resolution than standard video game consoles. Furthermore, there are significantly fewer games available for hand-held consoles than for standard video game consoles, due in part to those drawbacks. Due to the lack of processing power of the hand-held video game consoles, the graphic capabilities of the hand-held video game consoles is far inferior to that of the standard video game consoles. Therefore, the games for the hand-held video game consoles are not nearly as attractive, intricate or detailed as for the standard video game consoles, and thus are ultimately less appealing to a video game player.

Another problem with existing video game systems is that a television is required in order to use and enjoy the video game systems. The video game system cannot be used and enjoyed unless a television is available when the video game is desired to be played. This often leads to conflicts when one person wishes to play video games using the television to which the video game system is connected at the same time someone else wants to watch television programs on that television or use another device connected to that television.

A need exists for a portable video game system that overcomes the processing power and screen resolution problems described above with regard to hand-held video game consoles.

A further need exists for a portable video game system that overcomes the graphic capability problems described above with regard to hand-held video game consoles.

A still further need exists for a video game controller having an integrated display screen.

A still further need exists for a video game system not requiring a television screen to be used as the display screen.

### SUMMARY OF THE INVENTION

Accordingly, it is a primary objective of the present invention to provide a video game controller having a display screen for use with a video game console.

A further objective of the present invention is to provide a video game system that is more readily portable than existing video game systems.

A still further objective is to provide a portable video game system that overcomes the processing power, screen resolution and graphic capability problems of existing hand-held video game consoles.

The foregoing objects are basically attained by providing a video game controller assembly. The assembly has a controller adapted to communicate with a video game console for interfacing with a video game. A display monitor having a display screen integrally connected to the controller for displaying an image on the display screen corresponding to a video signal received from the video game console.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

Referring now to the drawings that form a part of the original disclosure:

FIG. 1 is a perspective view of a video game controller having an attached display screen according to the present invention;

FIG. 2 is a top view of the video game controller of FIG. 1.;

FIG. 3 is front view of the video game controller of FIG. 1;

FIG. 4 is a right side elevational view of the video game controller of FIG. 1;

FIG. 5A is a schematic diagram of the video game system of the present invention;

FIGS. 5B and 5C show connector modules for connecting to a video port of the video game console of FIG. 5A; and

FIG. 6 is a schematic diagram of the display screen of FIG. 1.

### DETAILED DESCRIPTION OF THE INVENTION

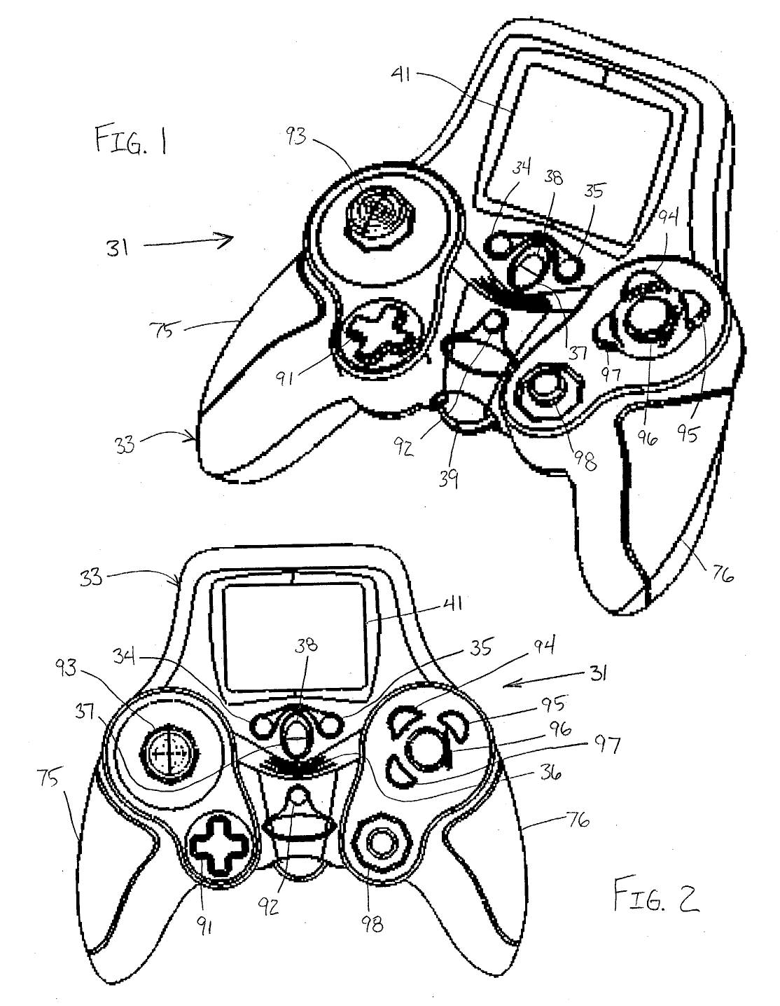

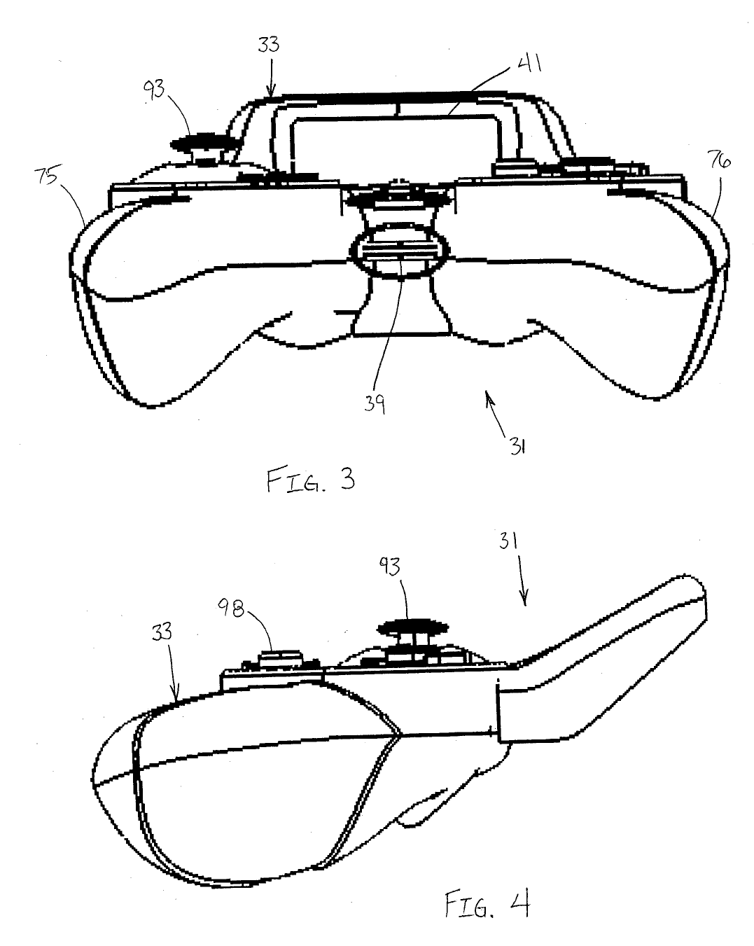

The present invention provides a video game system 11, as shown in FIGS. 1-6. The video game system 11, according to the present invention, includes a conventional video game console 21 and a video game controller 31 that has a display screen 41 attached to the video game controller, as shown in FIGS. 1-4. The video game console 21 is connected to a power source 51 that powers the video game system 11. The controller 31 and the display screen 41 are both connected to the video game console 21. The display screen 41 may be any type display, such as an LED, OLED or LCD, but preferably is an LCD.

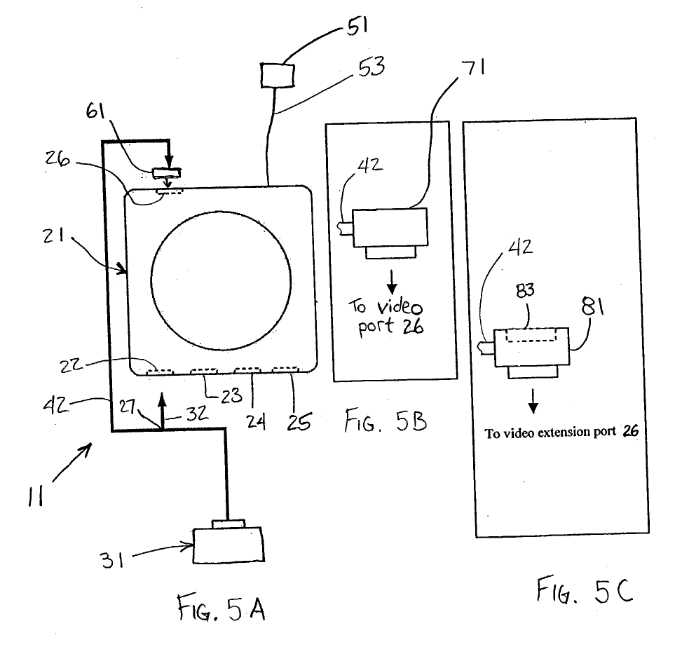

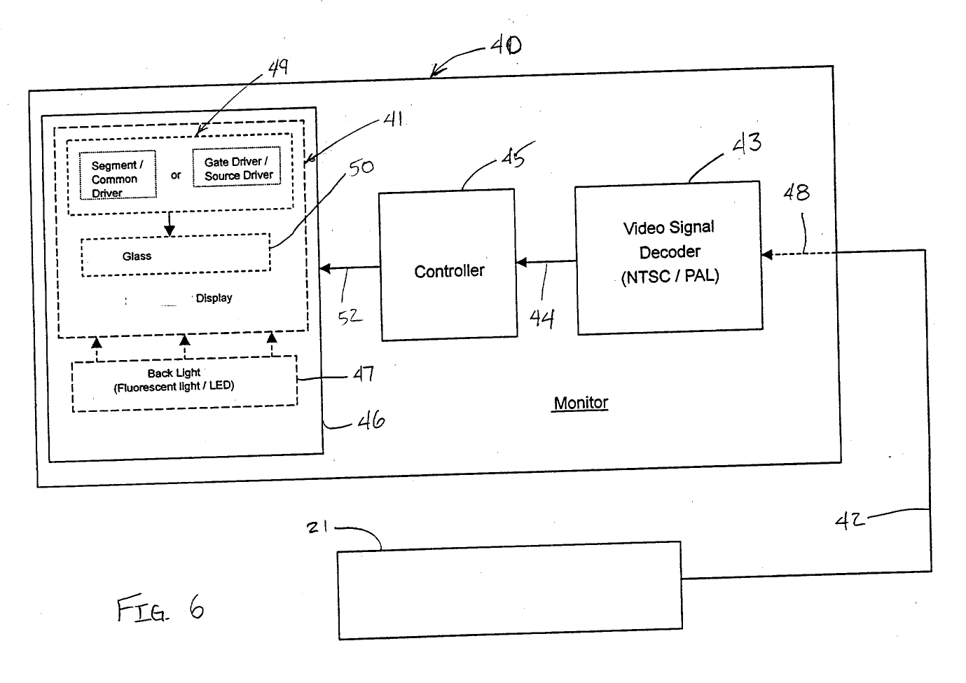

The video game console 21 is a conventional video game console, such as the Nintendo Gamecube or the Sony Playstation I or II. Since a conventional video game console is used, there are no processing and graphic capability problems that are inherent with hand-held video game consoles. Power cable 53 supplies power from the power supply 51 to the video game console 21, as shown in FIG. 5A. The power supply 51 may be any power source that provides adequate power for operation of the video game system 11, including, but not limited to, a standard electrical outlet and a power outlet in an automobile.

At least one controller port 22 on the video game console 21 receives a controller cable 32 from the video game controller 31. Preferably, the video game console 21 has four controller ports 22, 23, 24 and 25. At least one audio-video port 26 on the console 21 receives audio-video cable 42 from the controller 31 for transmitting audio-video signals from the video game console 21 to the display monitor 40 of the controller 31. The controller cable 32 and audio-video cable 42 may enter the controller housing 33 at the same location, thereby allowing cables 32 and 42 to be run together between the controller 31 and the cable split 27. Alternatively, wireless communication may be used to transmit signals between the controller 31 and the video game console 21.

A video game controller 31 with an attached display screen 41 of an LCD monitor 40 is shown in FIGS. 1-4. The LCD monitor 40 may be permanently or temporarily attached to controller 31. Preferably, the LCD monitor 40 is integral with video game controller 31 so that the display screen 41 is integral with the controller. The display screen 41 may be pivotably connected to the controller. Housing 33 contains the LCD monitor 40, as well as all the controls necessary for playing the video game. Preferably, the housing 33 secures the LCD monitor 40 and display screen 41 unitarily within the controller 31. Some typical controls are shown in FIGS. 1-4, such as, but not limited to, directional pad 91, start button 92, left analog stick 93, standard action buttons 94, 95, 96 and 97, and right analog stick (or camera stick) 98. Left grip 75 and right grip 76 facilitate a user's grip on the controller housing to provide a more enjoyable gaming experience. Preferably, the left and right grips 75 and 76 are made of rubber. Alternatively, any controller for playing a video game may be used, such as, but not limited to, the standard controller shown in FIGS. 1-4 or a steering wheel style controller.

A connector module 61 receives audio-video cable 42 from the controller 31, as shown in FIG. 5A. The connector module 61 plugs into the audio-video port 26 in the video game console 21. FIGS. 5B and 5C, show alternate connector modules. FIG. 5B shows a connector module 71 that receives a single audio-video cable and plugs into the audio-video port 26 of the console 21. FIG. 5C shows a connector module 81 that connects to the audio-video port 26 of the console 21 and that has a connector module port 83 for receiving additional connector modules 61. Connector module 81 connects multiple connector modules together, thereby allowing several display screens to receive the audio-video signal transmitted from the single audio-visual port 26 of the game console 21.

Preferably, the display screen 41 is an LCD having a TFT (Thin Film Transistor) or DSTN (Dual Scan Twisted Nematic) active non-glare matrix. An electrical schematic diagram of an LCD monitor 40 is shown in FIG. 6. The LCD display screen 41 has a video signal decoder 43 that receives an audio-video signal 48 from the video game console 21. The video signal received from the video game console includes, but is not limited to, NTSC, CAM, PAL, HDTV, digital and analog video signals. The decoded signal 44 is transmitted to the LCD controller 45, which in turn transmits a control signal 52 to the driver 49 that causes the driver to display an image on the glass 50 of the display screen 41 of the LCD module 46. The LCD module 46 may have a back light 47 to facilitate viewing the display screen 41 in dim and dark conditions by providing contrast. Preferably, the display screen 41 is approximately between 3 and 4 inches, inclusive.

The video game controller 31, as shown in FIGS. 1 and 2, allows a user to adjust certain features of the display screen 41, including, but not limited to, brightness of the screen and volume. A first knob 34 allows the user to control the brightness of the display screen 41. A second knob 35 allows the user to control the volume of speaker 36. Buttons 37 and 38 allow the user to increase or decrease, respectively, the brightness of the display screen or the volume. A headphone port 39 may be provided in the controller 31 for receiving headphones to provide private sound to the user. The remaining controls are standard controls for the particular video game console with which the controller is used to manipulate images or characters of the video display.

In another embodiment, the video game controller 31 has an audio member for receiving and playing an audio signal received from the video game console. Preferably, the audio member includes an amplifier that amplifies the received audio signal and a transducer for playing the amplified audio signal. Preferably, the transducer is a speaker 36. Alternatively, opening 39 may receive a plug to connect an earphone to the audio member so that a user may enjoy the audio without disturbing others in the vicinity.

By utilizing a conventional video game console 21, the video game system 11 of the present invention is not limited by the processing power, graphic capabilities and screen resolution problems as are the hand-held video game consoles. Since the video game system 11 includes only the video game console and the video game controller 31 having an attached display screen 41, the video game system is easily portable. Additionally, a television is no longer required to serve as the display screen because the video game controller 31 has an attached display screen 41, thereby eliminating conflicts over usage of the television.

While advantageous embodiments have been chosen to illustrate the invention, it will be understood by those skilled in the art that various changes and modifications may be made therein without departing from the scope of the invention as defined in the appended claims.

What is claimed is:

1. A video game controller assembly, comprising:
a controller adapted to communicate with a video game console for interfacing with a video game; and
a display attached to said controller for displaying an image corresponding to a video signal received from the video game console.

2. A video game controller assembly according to claim 1, wherein
said display is an LCD display screen.

3. A video game controller assembly according to claim 2, wherein
said LCD display screen is color or black and white.

4. A video game controller assembly according to claim 2, wherein
said LCD display screen is an STN, DSTN or TFT LCD display screen.

5. A video game controller assembly according to claim 1, wherein
said display is an LED or OLED display screen.

6. A video game controller assembly according to claim 1, wherein
said display has a video signal decoder for receiving and decoding a video signal.

7. A video game controller assembly according to claim 6, wherein
the video signal received by said video signal decoder is selected from the group consisting of NTSC, CAM, PAL, HDTV, digital and analog video signals.

8. A video game controller assembly according to claim 1, wherein
an audio member is integrally connected to said video game controller for receiving and playing an audio signal received from the video game console.

9. A video game controller assembly according to claim 8, wherein
said audio member has an amplifier for receiving the audio signal from the video game console, and a transducer connected to said amplifier for playing the amplified audio signal.

10. A video game controller assembly according to claim 6, wherein
said display has an LCD controller for receiving the decoded video signal and displaying an image.

11. A video game controller assembly according to claim 10, wherein
said LCD controller transmits a control signal to a driver for displaying said image on said display.

12. A video game controller assembly according to claim 1, wherein
said controller is electrically connected to the video game console.

13. A video game controller assembly according to claim 12, wherein
a cable connected to said controller electrically connects said controller to the video game console, said cable having a connector module that connects to the video game console.

14. A video game controller assembly according to claim 13, wherein
said connector module has a port for receiving additional connector modules from additional video game controllers.

15. A video game controller assembly according to claim 1, wherein
said controller is wirelessly connected to the video game console.

16. A video game controller assembly according to claim 1, wherein
a back light is connected to said display to facilitate viewing said display.

17. A video game controller assembly according to claim 1, wherein
said display is pivotably attached to said controller.

18. A video game controller assembly according to claim 1, wherein
said display is integrally connected to said controller.

19. A video game controller assembly, comprising
a controller adapted to communicate with a video game console for interfacing with a video game; and
a display attached to said controller for receiving a video signal from the video game console, said display including
a decoder for receiving and decoding the video signal;
a controller for receiving said decoded signal and transmitting a control signal;
a driver for receiving said control signal and transmitting a drive signal; and
a display screen for displaying an image corresponding to said received drive signal.

20. A video game controller assembly according to claim 19, wherein
said display screen is an LCD display.

21. A video game controller assembly according to claim 20, wherein
said LCD display screen is color or black and white.

22. A video game controller assembly according to claim 20, wherein
said LCD display is an STN, DSTN or TFT LCD display.

23. A video game controller assembly according to claim 19, wherein
said display screen is an LED or OLED display.

24. A video game controller assembly according to claim 19, wherein
the video signal received by said video signal decoder is selected from the group consisting of NTSC, CAM, PAL, HDTV, digital and analog video signals.

25. A video game controller assembly according to claim 19, wherein
an audio member is integrally connected to said video game controller for receiving and playing an audio signal received from the video game console.

26. A video game controller assembly according to claim 25, wherein
said audio member has an amplifier for receiving the audio signal from the video game console, and a transducer connected to said amplifier for playing the amplified audio signal.

27. A video game controller assembly according to claim 19, wherein
said controller is electrically connected to the video game console.

28. A video game controller assembly according to claim 27, wherein
a cable connected to said controller electrically connects said controller to the video game console, said cable having a connector module that connects to the video game console.

29. A video game controller assembly according to claim 28, wherein
said connector module has a port for receiving additional connector modules from additional video game controllers.

30. A video game controller assembly according to claim 19, wherein
said controller is wirelessly connected to the video game console.

31. A video game controller assembly according to claim 19, wherein
a back light is connected to said display screen to facilitate viewing said display screen.

32. A video game controller assembly according to claim 19, wherein
said display is pivotably attached to said controller.

33. A video game controller assembly according to claim 19, wherein
said display is integrally connected to said controller.

34. A method of displaying an image on a video game controller assembly, comprising the steps of:
sending a video signal from a video game console to the controller interfacing with a video game playing on the video game console;
decoding the video game signal with a decoder connected to the controller;
converting the decoded signal from the decoder to a control signal with a controller;
displaying an image on a display screen attached to the controller with a driver responding to the control signal.

35. A method of displaying an image on a video game controller assembly according to claim 34, wherein
decoding the video game signal with a decoder comprises decoding a video signal selected from the group consisting of NTSC, CAM, PAL, HDTV and digital video signals.

36. A method of displaying an image on a video game controller assembly according to claim 34, further comprising
receiving an audio signal from the video game console with a speaker assembly connected to the video game controller; and
producing sound with the speaker assembly corresponding to the received audio signal.

37. A method of displaying an image on a video game controller assembly according to claim 36, further comprising
adjusting the volume of the produced sound with controls connected to the video game controller assembly.

38. A method of displaying an image on a video game controller assembly according to claim 34, further comprising
adjusting the image displayed on the video screen with controls connected to the video game controller assembly.

39. A method of displaying an image on a video game controller assembly according to claim 34, wherein
sending a video signal from a video game console to the controller comprises sending the video signal by a wireless connection between the controller and the video game console.

40. A method of displaying an image on a video game controller assembly according to claim 34, wherein
sending a video signal from a video game console to the controller comprises sending the video signal by an electrical connection between the controller and the video game console.

41. A method of displaying an image on a video game controller assembly according to claim 40, further comprising
electrically connecting the controller to the video game console with a connector module connected to the controller.

42. A method of displaying an image on a video game controller assembly according to claim 41, further comprising
electrically connecting additional controllers to the video game console by connecting the additional controllers to the connector module.

43. A video game controller assembly, comprising:
a controller adapted to communicate with a video game console for interfacing with a video game;
and an audio member integrally connected to said controller for receiving and playing an audio signal received from the video game console.

44. A video game controller assembly according to claim 43, wherein
said audio member has an amplifier for receiving the audio signal, and a transducer connected to said amplifier for playing the amplified signal.

45. A video game controller assembly according to claim 44, wherein
said transducer is a speaker.

46. A video game controller assembly according to claim 43, wherein
said controller has an opening for receiving a plug to connect an earphone to said audio member.

47. A video game controller assembly according to claim 43, wherein
a display is attached to said controller for displaying an image corresponding to a video signal received from the video game console.

48. A video game controller assembly according to claim 43, wherein
said display is an LCD display screen.

49. A video game controller assembly according to claim 43, wherein
said display is an LED or OLED display screen.

50. A video game controller assembly according to claim 43, wherein
said display is pivotably attached to said controller.

51. A video game controller assembly according to claim 43, wherein
said display is integrally connected to said controller.

52. A video game controller assembly according to claim 43, wherein
said controller is wirelessly connected to the video game console.

53. A video game controller assembly according to claim 43, wherein
said controller is electrically connected to the video game console.
